(19) United States
(12) Patent Application Publication
(10) Pub. No.: US 2025/0323481 A1
(43) Pub. Date: Oct. 16, 2025

(54) Electrical Wiring Bus Panel

(71) Applicant: Mark Bessett, Goodyear, AZ (US)

(72) Inventor: Mark Bessett, Goodyear, AZ (US)

(21) Appl. No.: 19/055,853

(22) Filed: Feb. 18, 2025

Related U.S. Application Data
(60) Provisional application No. 63/611,714, filed on Dec. 18, 2023.

(51) Int. Cl. H02G 3/18; H02G 3/38

(52) U.S. Cl. CPC H02G 3/18; H02G 3/288

(57) ABSTRACT

An electrical wiring bus panel for providing electricity to at least one component (and preferably more) of an electrical system that comprises a matrix, modular configuration including a bus with a plurality of horizontal and vertical rails, each rail having at least one port through which electrical connections can be made, the rails including at least a ground line rail, a neutral line rail and a power line rail, although additional rails can be added and the bus panels can be ganged together. The panel is color coded and the ports are of plug and play configurations that are different in shape and size for each rail to reduce the amount of installation and modification time and effort and the likelihood of error.

### CROSS REFERENCE TO RELATED APPLICATIONS

This application claims the benefit of U.S. Provisional Application Ser. No. 63/611,714, filed on Dec. 18, 2023, which is hereby incorporated by reference herein.

### FIELD OF THE INVENTION

The invention relates to electrical wiring bus systems and methods of providing electrical wiring and connections to buildings and other installations.

### BACKGROUND OF THE INVENTION

In the electrical wiring in a building and other installations, the common practice of distribution is using wire nuts and junction boxes. An electrician typically runs wire from a central breaker box to the outlets and points in the building where electrical current is needed or desired. The process and technique are very labor intensive.

The wire is often run, or distributed, within metal or plastic conduit, or nylon sheathing. Where these conduits meet, the wires are stripped and wound together with the next wire using wire nuts. These nuts are simply metal spiral-like springs with a plastic cap and are literally screwed down over the bare metal wires. These systems are time-consuming, lack uniformity which itself leads to problems and potential dangers, and error prone.

Recently, these wire nuts were changed to push-connectors that provide contact to a common electrical material. The push-connectors are a minimal improvement at best over the wire nuts, and in fact are often not used because the wire in the connector must be sacrificed when any rewiring occurs.

Different systems and methods for providing electricity to buildings and other installations are needed to overcome these and other disadvantages of current systems and methods.

### SUMMARY OF THE INVENTION

Certain embodiments of this invention include an electrical bus panel. In the most preferred embodiments, the bus panel is in the form of a matrix or a particular configuration of components. The nature of the electrical bus panel matrix of these embodiments affords a more reusable and modular approach offering improved safety, expansion and extensibility. These embodiments have a configuration that offers conductive “bus” rails (aka bus bars, busbars, bus plates, busways, etc.) that are specifically organized to meet the needs of wiring in buildings, though other similar use cases (e.g., boats, ships, outdoor and/or underground installations, vehicles, airplanes) are suitable. The arrangement of the system makes wiring a “plug and play” experience, acknowledging the requirements of electrical switches and loads, and the typical need to take electrical current from one junction to the next. Furthermore, the configuration with these embodiments is very intuitive, easy to follow, and maintenance friendly. In particular, the rails in these embodiments provide electrically similar connectivity for the adjacent connections. For example, all ground, line, etc., switched rails are provided for connecting a load to line power for single-pole, 3-way switches, or traveler lines for 3-way and 4-way switches.

The matrix in these embodiments is divided into groups that make it clear where power input is coming in and where it potentially exits to the next box or is utilized by various switches and electrical appliances or other loads. Users can simply “plug into” the intuitive arrangement rather than disassemble wiring, which is often convoluted, and which is often different and inconsistent with other sites' installations, depending on the original electrician.

Embodiments of the electrical bus panel matrix seek to provide improved safety for electrical connections, more convenient and simplified electrical installations, troubleshooting, and maintenance, as well as provide for advancing technology, telemetry and diagnostics.

To these ends, embodiments of this invention facilitate disconnecting the line power, or source current, directly at the box in a safe manner. Certain activities, such as panel installation, still require disconnecting the power at the breaker for maximum safety, while this design, once installed, offers safety by making each consumer in the junction box an isolated component. It should therefore be safe to connect and disconnect components even while the power to the panel is active. This is a critical concern during maintenance where power cutoff can be problematic if, for example, a non-dedicated breaker controls many other devices, components or loads. This is a primary issue for healthcare, communication, and security related uses.

Since the bus panel's matrix is a standard form factor, any participating form factors can be added directly and conveniently at the switch or junction box and directly into breaker box electrical runs. Such uses can be for telemetering usage at a granularity greater than the main breaker, but less cumbersome than devices beyond the outlet.

Certain embodiments of this invention are also designed to participate in the current form factor of electrical boxes, to be comparable with the current wiring techniques and standards. This is not a requirement of the invention, however, although it is an option of some embodiments.

Certain preferred embodiments of this invention are comprised of multiple components, primarily centering around a bus panel with access in a unique combination to physically connected rows and logical columns. This allows any device in the junction or switch box to have simple, safe, and direct access to power being delivered on any source wire, namely phase lines, neutral, and ground connections. The arrangement sets forth a safer, uniform, more convenient and simpler plug-and-play experience for any technician or end user.

A plurality of bus plates that correspond to junction box form factors are available directly in the junction box itself. Electrical components consuming electrical power are fitted as they are today to the box structure but are electrically connected to the bus plate.

The preferred bus plate contains intrinsic wiring to connect ports which are accessible to various components. The main power bus distributes current available at the box on rails for NEUTRAL, GROUND and one- or two-LINE power wires, each providing 120V (i.e., 120 volts) AC power, optionally allowing 240V in certain embodiments. Any component requiring power simply accesses it by plugging the device wires into the ports attached to the bus. It should be noted that these ports are each isolated so that they do not contact anything but the intended bus. Power sources and extensions are electrically attached to the bus and available, again isolated from direct contact with their consuming components such as switches and switchable loads.

Certain embodiments of this invention also provide simple, mistake-proof connections for power, loads and switches. The use of keyed connections, color identification and composite plugs (“coded” or “coding” of connections) is preferably made. The LINE power connections are also removable in these embodiments so power can be easily and safely disconnected at the junction box location without risk of shock or shorts, like unplugging an extension cord.

Particularly preferred embodiments are electrical wiring bus panels for providing electricity to at least one component (e.g., an appliance, receptacle, light fixture, etc.), and more preferably more components, of an electrical system (e.g., the electrical wiring for a building). These bus panels comprise a bus. The bus comprises a plurality of rails, wherein each rail comprises at least one port (and more preferably two or more) through which electrical connections to the rail can be made. The rails are organized in horizontal and vertical columns, appropriately separated and insulated against the surrounding space, as well as from each other where required. The rails are capable of being attached to an electrical power source (and grounding, etc.) as needed. The rails further comprise at least three types of rails, the three types of rails comprising at least a ground line rail, a neutral line rail, and a power line rail. The ports for each rail are of a unique and uniform shape and size for each rail and can be used to differentiate the rails from one another (e.g., for ease of use, installation and safety, and the reduction of errors). The ports accept connectors of unique and uniform shape and size for each port. The ports can be connected to the component of the electrical system without tools by pushing the matching connectors for each port into place. The bus is contained in a panel that is coded (e.g., colors, labels, etc.) to indicate the types of rails for ease of use, installation and safety, and the reduction of errors. The connected component of the electrical system can be connected to at least one of the rails of the bus through at least one port of that rail.

These preferred bus panels may be capable of being connected to another bus panel to form a multiple bus panel gang configuration. In addition, the plurality of rails may further comprise a switched line rail for providing a single-pole connection, one or more additional power line rails, a switched line rail for a 3-way switch, a traveler line for a 3-way switch, and/or a traveler line for a 4-way switch.

These preferred bus panels may also comprise a safety header that connects to ports of the rails to electrically isolate one of the components of the electrical system (e.g., to safety work on it, replace it, etc.).

These preferred bus panels may be for 120V components of an electrical system. Alternatively, it may be for 240V components of an electrical system, in which case it may have an additional power line rail as compared to the 120V embodiments.

Certain preferred embodiments of this invention also include (1) integrated wireless communication capabilities for monitoring and controlling electrical installations remotely; (2) automated diagnostic and fault resolution features; (3) a scalable and customizable modular configuration designed to accommodate different building sizes and requirements, including integration with renewable energy sources; (4) enhanced safety features, including automatic circuit isolation and improved material resistance to environmental hazards; (5) optimization for energy efficiency and sustainability, supporting low-power devices and renewable energy integration; and (6) an enhanced user interface and accessibility features to accommodate a broader range of users.

Other particularly preferred embodiments are electrical wiring bus panels for providing electricity to at least one component of an electrical system. In these embodiments, the bus panels comprise a bus. Each bus comprises a plurality of rails, each rail comprising at least one port through which electrical connections to the rail can be made, the rails organized in horizontal and vertical columns, and the rails are capable of being attached to an electrical power source. The plurality of rails further comprise at least a ground line rail, a neutral line rail, a power line rail, a switched line rail for providing a single-pole connection, a switched line rail for a 3-way switch, a traveler line for a 3-way switch and/or a traveler line for a 4-way switch. The ports for each rail are of a unique and uniform shape and size for each rail and can be used to differentiate the rails from one another. The ports accept connectors of unique and uniform shape and size for each port. The ports can be connected to the components of the electrical system without tools by pushing the connectors into place. These embodiments also comprise a panel that contains the bus, the panel being coded to indicate the types of rails, and the panel is capable of being connected to another bus panel to form a multiple bus panel gang configuration. The component of the electrical system can be connected to at least one of the rails of the bus through at least one port of that rail.

Still other particularly preferred embodiments are module systems for forming electrical wiring bus panels for providing electricity to components of an electrical system. The modular systems comprises a number of components, including at least one bus module and at least one panel module. The bus module is capable of comprising a plurality of rails, each rail comprising at least one port through which electrical connections to the rail can be made, the rails organized in horizontal and vertical columns, and the rails are capable of being attached to an electrical power source. The plurality of rails further comprise a ground line rail, a neutral line rail, a power line rail, a switched line rail for providing a single-pole connection, a switched line rail for a 3-way switch, a traveler line for a 3-way switch and/or a traveler line for a 4-way switch. The ports for each rail are of a unique and uniform shape and size for each rail and can be used to differentiate the rails from one another. The ports accept connectors of unique and uniform shape and size for each port and the ports can be connected to the component of the electrical system without tools by pushing the connectors into place. The panel module that is capable of containing the bus module and the panel module is coded to indicate the types of rails. The panel module is also capable of being connected to another bus panel to form a multiple bus panel gang configuration. The component of the electrical system can be connected to at least one of the rails of the bus through at least one port of that rail. The bus modules, rails, and panel modules are selected based upon the electrical requirements of the one component (and more preferably, other components also).

In particularly preferred embodiments of this invention, an electrical bus panel for installation of at least one of multiple types of devices is provided. The types of devices for these embodiments comprise switches, outlets, appliances, and others (e.g., including a smart light switch). The bus panel of these embodiments comprise multiple bus rails and multiple bus panel ports. The bus panel rails comprise a line rail, a neutral rail, a ground rail, and/or a traveler rail, and they can include additional rails as well. The bus panel ports are each configured to accept the installation of at least one of multiple plug-and-play connectors. These connectors may have one or connections (e.g., to connect to multiple ports).

Each plug-and-play connector in these embodiments is configured, keyed and coded for, and attached to, one type of device. The installation of the plug-and-play connector on the bus panel port does not require any adapters, additional components, additional wiring, tools, wire stripping, or intermediary connectors. The installation of each plug-and-play connector aligns each type of device with the correct, particular bus panel rails. The use of plug-and-play connectors with this electrical panel reduces installation time, complexity, potential points of failure, and errors in installation.

Advantages of the embodiments of this invention are described and apparent throughout the specification. For example, certain embodiments provided more efficient installation, maintenance and modification of electrical supply to components in a building. Certain embodiments through use of uniform pins and connectors and/or coding reduce potential errors, and safety concerns, and reduce ambiguity and confusion. Further advantages will be apparent to a person of skill in the art applying the embodiments of the invention.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a schematic showing a single-gang, single-pole switched connection using a bus approach.

FIG. 2 is a schematic showing a 3-way switch configuration and interconnectivity for 3-way switch installation and interconnecting conduits, appliances and power source.

FIG. 3 is a schematic showing a typical 4-way switch configuration and 4-way switch installation connectivity.

FIG. 4 is a schematic showing “daisy chaining” bus panels with and between junction or switch boxes.

FIG. 5 is a schematic showing logical configurations of single 120V and 240V embodiments.

FIG. 6 is a schematic showing logical configurations of certain single 3-way line embodiments, single 4-way embodiments (with a connected appliance, such as a light, fan or outlet), and single 3-way load embodiments.

FIG. 7 is a schematic showing embodiments supporting single-pole switches, or one 3-way or 4-way switch.

FIG. 8 is a schematic showing an optional embodiment for consolidation of bus ports to support of up to three single-pole, two 3-way switches, or two 4-way switches.

FIG. 9 is a schematic showing an embodiment supporting up to four single-pole switches, or two 3-way or 4-way switches, as well as two additional single-pole switches.

FIG. 10 is a schematic showing a connectivity arrangement for a multi-gang embodiment supporting up to five single-pole switches, or up to three 3-way or 4-way switches, and extensible as needed.

FIG. 11 is a schematic showing a safety jumper embodiment wherein removal of a jumper from a safety header provides safety for the entire panel, and wherein multiple panels can by joined for extensibility in a modular fashion.

FIG. 12 is a schematic showing an embodiment for use with single-pole switched or unswitched loads that also facilitates extension.

FIG. 13 is a schematic showing a preferred embodiment for a single-gang, all-purpose bus panel that extends the embodiment of FIG. 12 for 3-way and 4-way switched loads.

FIG. 14 is a schematic showing a safety jumper to connect several 120V bus panels and/or a safety header without requiring any exposure to live wires or connections.

FIG. 15 is a schematic showing a composite plug embodiment that is unswitched and aligned for a 120V bus panel supplying constant power.

FIG. 16 is a schematic showing a composite plug embodiment that is switched and aligned for a wiring bus supplying constant power.

FIG. 17 is a schematic showing a composite plug embodiment that is single-pole, switched and aligned for a wiring bus supplying constant power.

FIG. 18 is a schematic showing a composite plug embodiment that is 3-way line-side and aligned for a wiring bus supplying constant power.

FIG. 19 is a schematic showing a composite plug embodiment that is 3-way load-side and aligned for a wiring bus supplying constant power.

FIG. 20 is a schematic showing a toggled connector embodiment to support both load and line sides of a 3-way switch.

FIG. 21 is a schematic showing a 240V connector embodiment with an extra line phase.

FIG. 22 is a schematic showing a 120V and 240V connector disambiguation approach for safety.

FIG. 23 is a schematic showing a generalized embodiment of a bus panel.

FIG. 24 is a schematic showing a bus panel embodiment integrated into a standard junction/switch box.

FIG. 25 is a schematic of an example of a 120V embodiment illustrating bus rail connectivity.

FIG. 26 is a schematic of a bus panel embodiment with an exploded view of wire connectors for single-pole switch and load.

FIG. 27 is a schematic of a panel bus embodiment with a view of connectors for a single-pole switch and connected load.

FIG. 28 is a schematic of a bus panel embodiment with an exploded view of connectors for 3-way switch configuration, with traveler connection.

FIG. 29 is a schematic of a bus panel embodiment with a view of 3-way switch support for the line side, and wherein the load side 3-way switch has a disambiguated connector as the appliance load, which would not be connected to this panel for this configuration, and wherein the load side and line side differ only by the connector in the bus.

FIG. 30 is a schematic of a bus panel embodiment with a view of 3-way switch support for the load side.

FIG. 31 is a schematic of a bus panel embodiment with a view of 4-way switch support and associated traveler connections, wherein in this configuration, there is typically no requirement for a power source if there is only unpowered 4-way switch in the box.

FIG. 32 is a schematic of joined bus panel (Bus Panel A and Bus Panel B) embodiments, joined via an extension jumper to support multiple configurations, with a view of extension and power connectors.

FIG. 33 is a schematic of a bus panel embodiment with a view of a hard-wired safety header and exploded view of a removable safety jumper.

FIG. 34 is a schematic of a bus panel embodiment with a view of a hard-wired safety header and attached safety jumper, providing connection to the bus panel.

FIG. 35 is a schematic of a 120V integrated, multi-gang bus panel embodiment.

FIG. 36 is a schematic of a 240V bus panel embodiment, providing switched support, but without a traveler feature, which is suitable for a box supporting an appliance, receptacle or similar use case.

FIG. 37 is a schematic of a 240V bus panel embodiment with a view of power and extension connectors attached.

FIG. 38 is a schematic of a 240V bus panel embodiment with an exploded view of power and extension connectors (which are not attached).

FIG. 39 is a schematic of additional bus matrix embodiments of this invention.

### DETAILED DESCRIPTION OF THE INVENTION

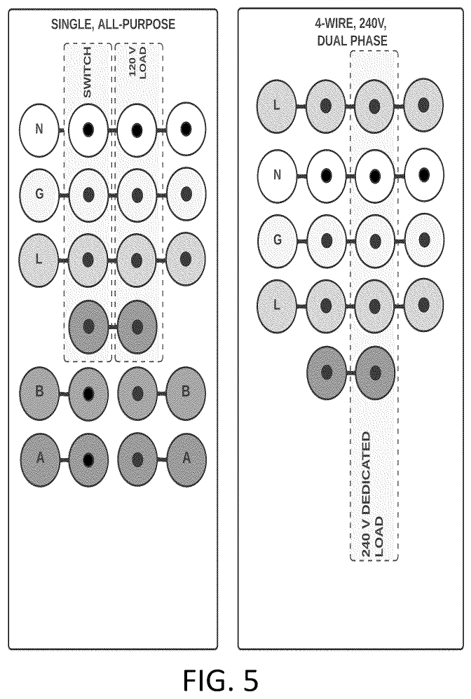

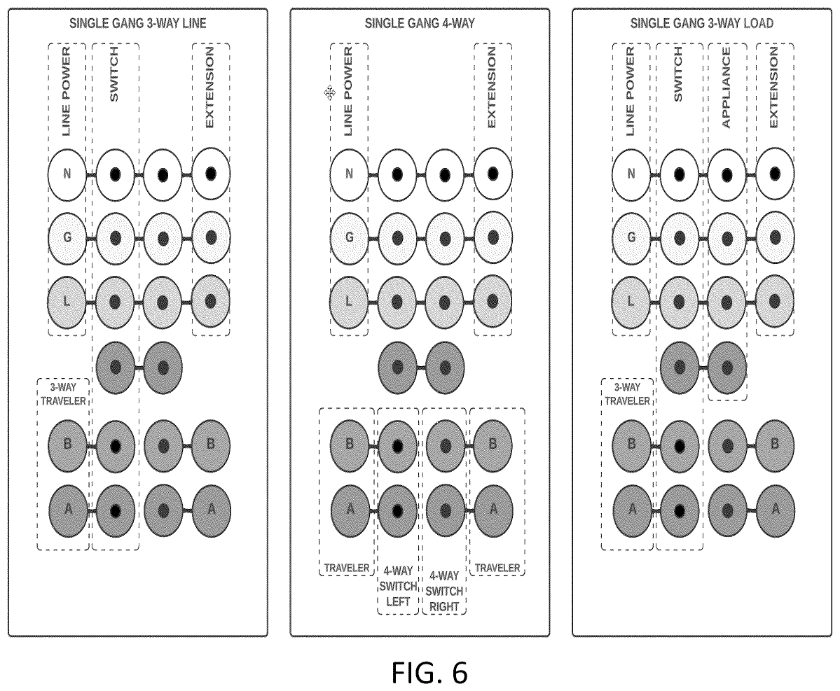

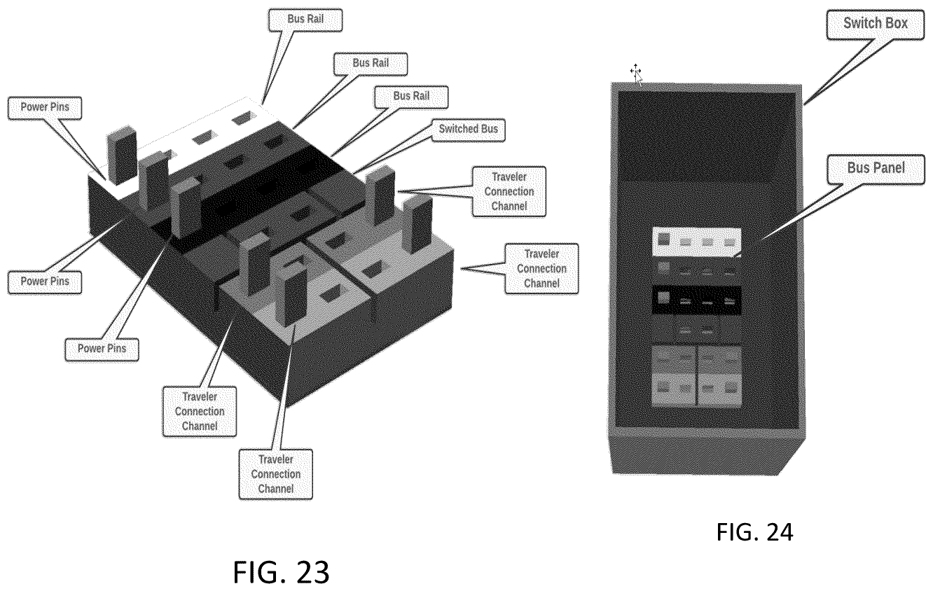

In certain preferred embodiments of this invention, the arrangement of the bus rails is laid out such that adjacent ports are available for consumption to each of the bus rails. A switch rail is also present that allows line power to connect to the switch rail in accordance with the switch's position. The switch rail has only two adjacent ports, one for the switch, and one for the switched load, and is otherwise disconnected from any other bus rails. When the switch is on the “on” position, it electrically connects the LINE power to the switch rail, and thereby to the paired switched load. The switched load connector has no direct LINE wire bus contact and relies solely on the switch rail for current. FIG. 5 and FIG. 6 show these connections schematically for the most basic bus panel. FIG. 23 is a generalized embodiment of a bus panel of this invention. FIG. 24 is a bus panel embodiment integrated into a standard junction/switch box.

In certain preferred embodiments, the connector holes for the rails are of a different size and/or shape for each type of rail. In these embodiments, successful installation is improved and the chance of error is reduced.

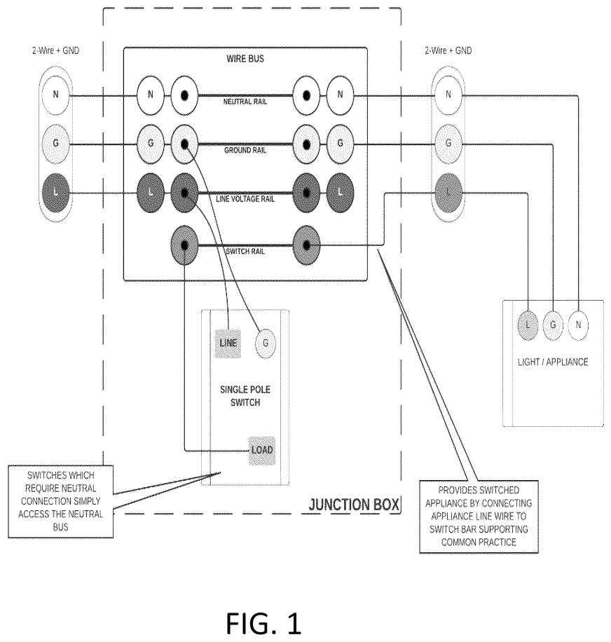

Single-pole switches simply connect or disconnect the LINE power to its accompanying switch rail. FIG. 1 illustrates the bus panel in this most simple switch and load configuration as a schematic. The single-pole switch simply applies the LINE bus rail to the switch rail when in the “on” position. When in the “on” position, the switch powers the switch bus, which only has one other device attachable, referred to as the “load.”

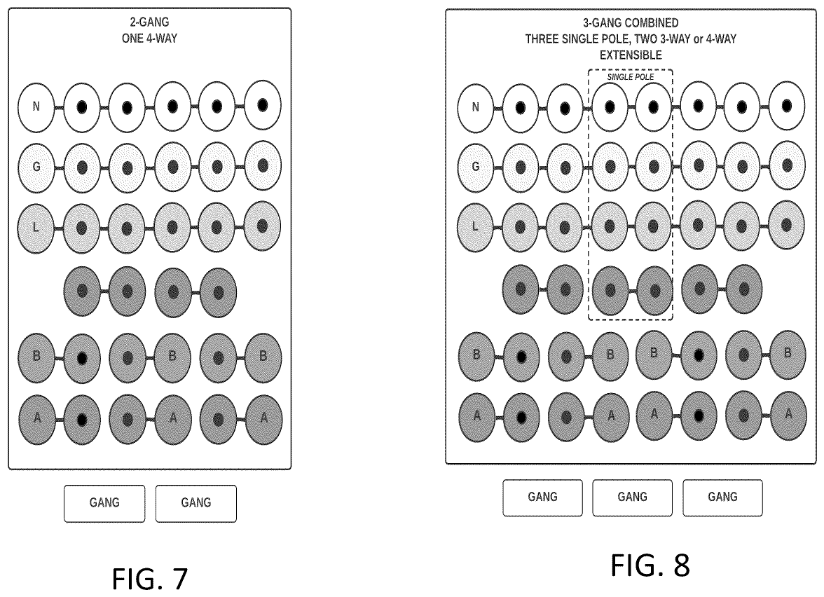

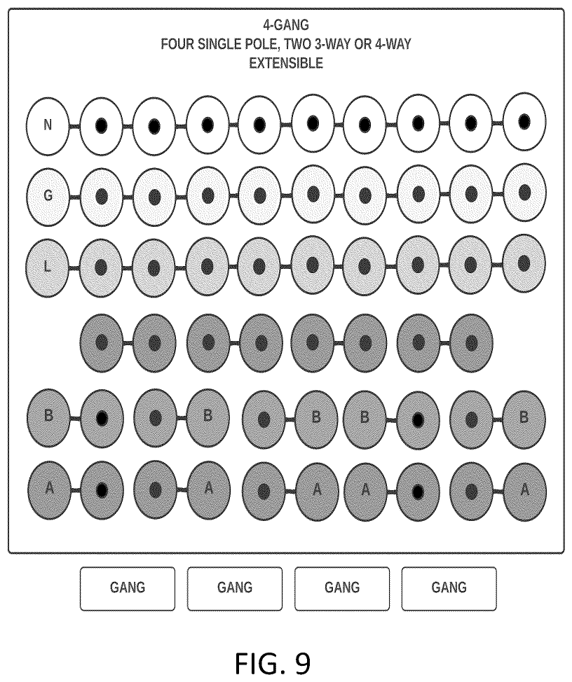

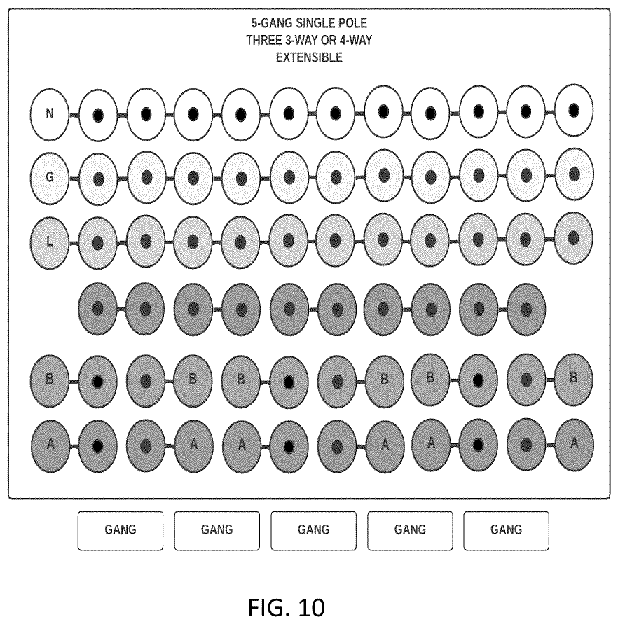

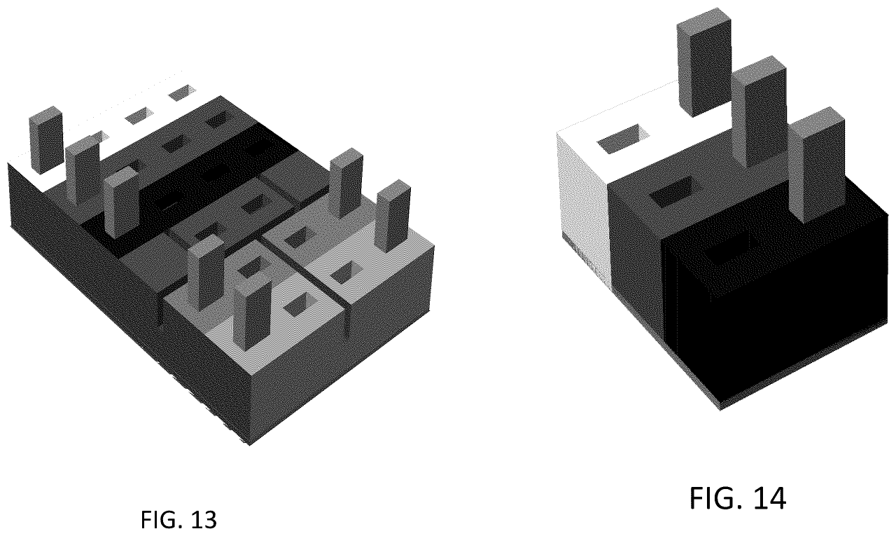

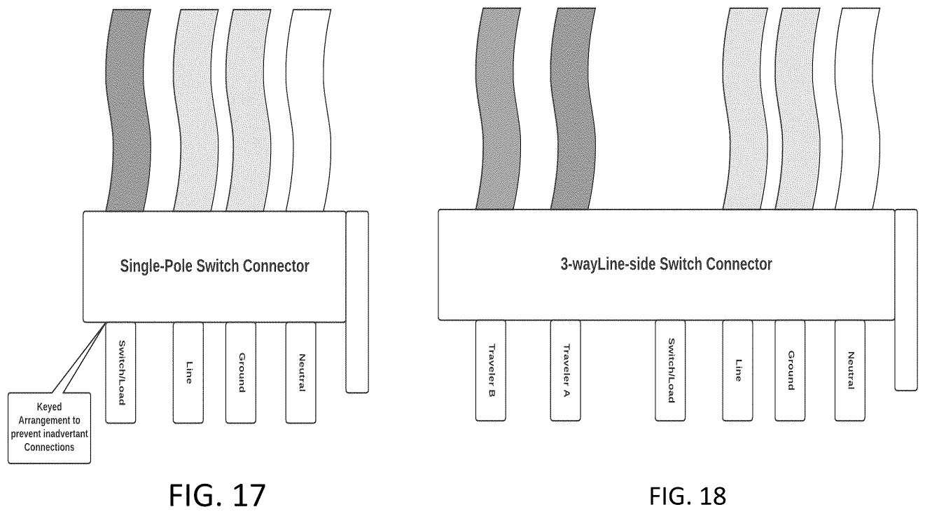

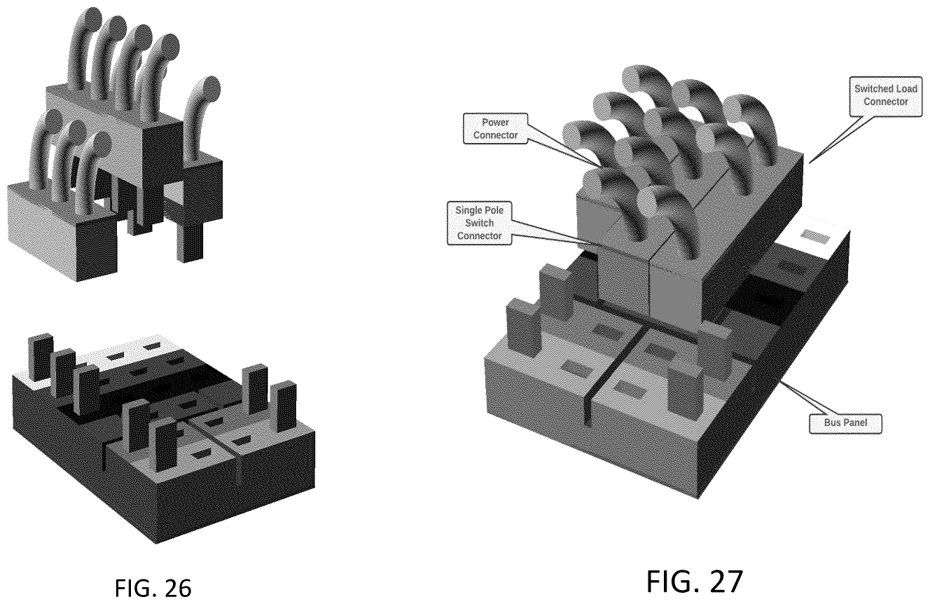

FIGS. 1, 7, 9-10, 12-13, 17 and 26-27 illustrate single-pole switch and load embodiments.

However, 3-way switches switch one power input to one of two available wires, commonly called “traveler” wires. The bus panel accommodates the traveler wires by allowing them to connect to another part of the bus where two traveler switch rails are connected to the 3-way switch. The traveler wires leave the junction box and connect to another 3-way switch on a remote junction box. Another 3-way switch in the remote junction box is similarly connected to the switched load. The switch is also connected to a third port which is a switch rail to which the appliance relies on for power in the same manner as the single-pole use case.

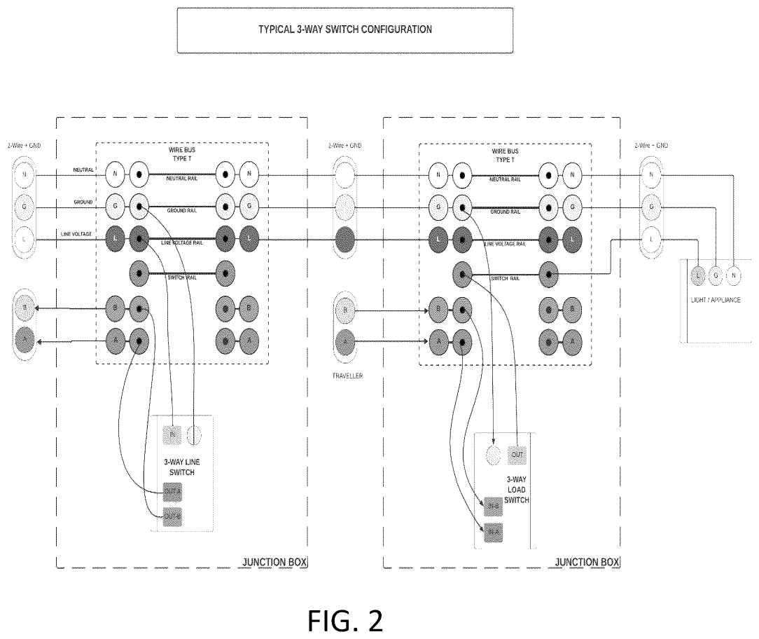

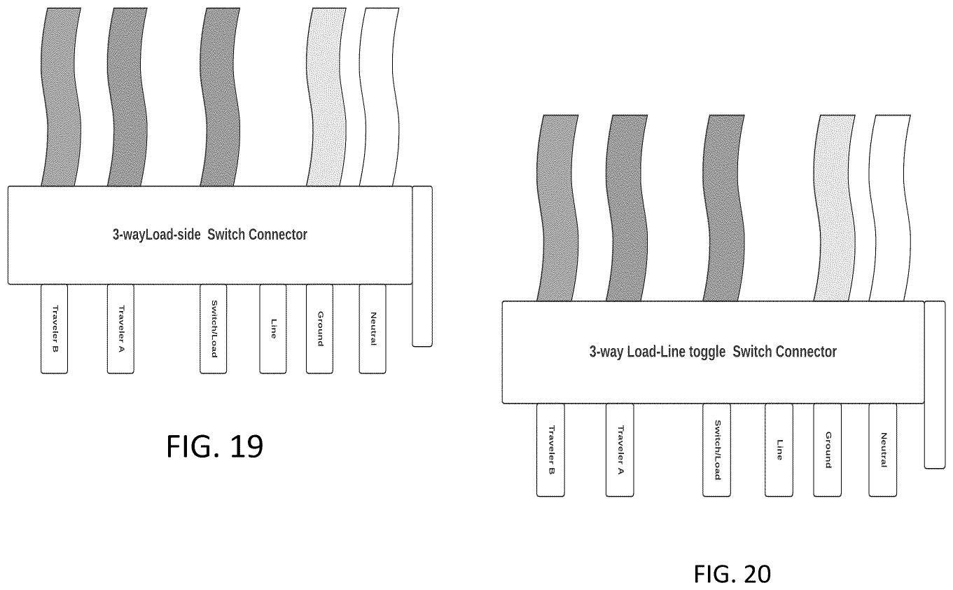

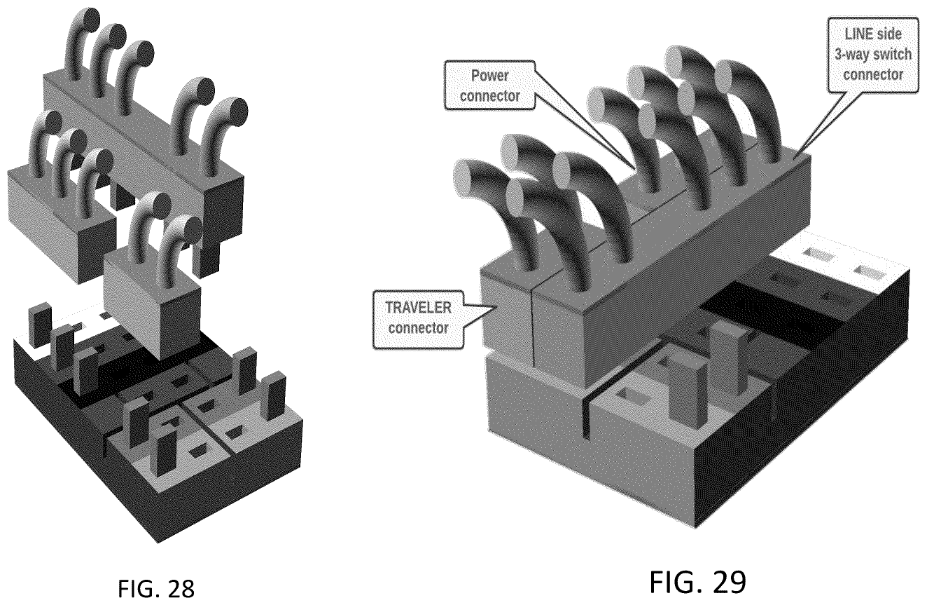

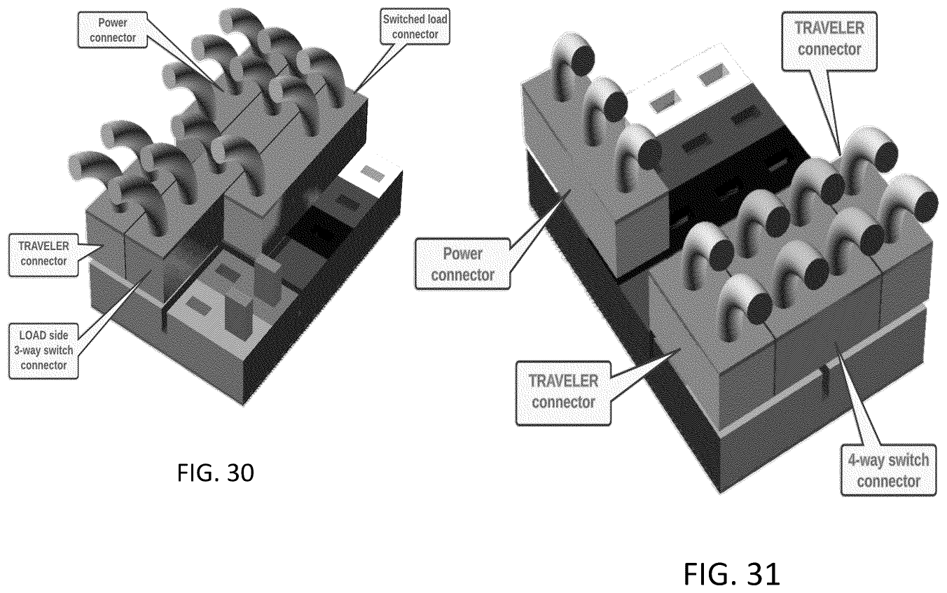

FIGS. 2, 6-10, 13, 18-20 and 28-30 illustrate 3-way switch and load configuration embodiments.

Another common switch is a double throw-double-pole switch, also known as a 4-way switch. This switch, when used, is electrically in between two 3-way switches such that it emulates a 3-way switch on both sides. Multiple 4-way switches can also be connected electrically between the 3-way switches if desired. This essentially extends the single-pole switching action to other remote switches. At each end, there is a 3-way switch, one connected to the “LINE” side providing current on one of the two traveler wires, and the other connected to the bus panel's switch rail for the appliance being switched.

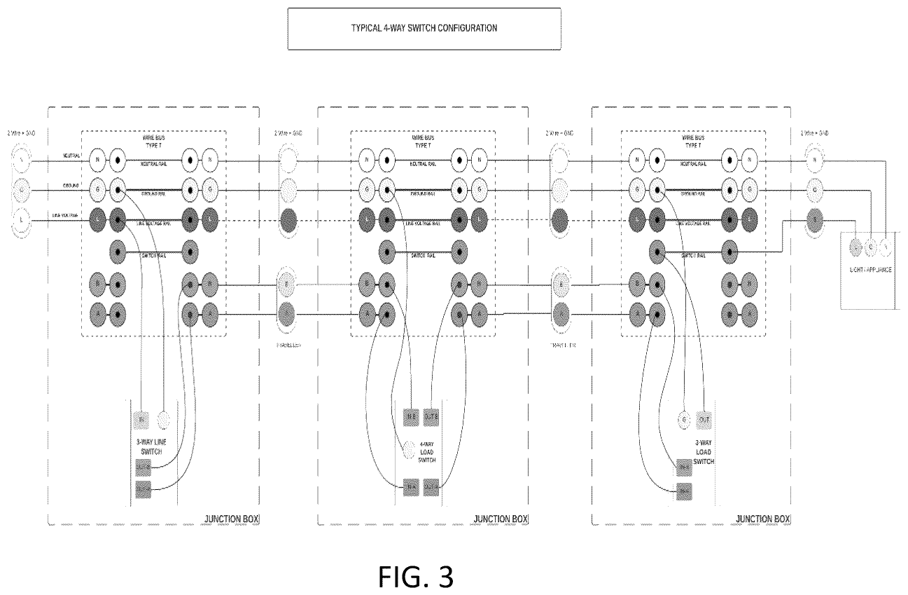

FIGS. 3, 6-10, 13 and 31 illustrate 4-way switch and load configuration embodiments.

The bus panel's ports are also aligned intuitively for these 3-way switch implementations, with the two traveler ports aligned with the power and switch rail ports. Each 4-way switch is connected to two traveler ports for traveler wires heading towards their counterpart switches. This intuitive arrangement allows for significant modularity of wiring needs, while still providing electrical isolation at the bus panel's ports.

The bus panel in its simplest form merely has ports accessible and suitable for a push-connect experience where the user simply aligns the wire color, and uses the intended columnar orientation for the component connections.

On the ends of the bus rails, the source power is connected such that the source power cable has a socketed connector. When the connector is removed, there is no power to the bus, or the downstream extension, if one is attached. The extension ports are similar, but female socket such that the panels may be daisy-chained together for multiple switch gang configurations where there are a plurality of attached switches and appliances connected. The intended socket design for potentially “hot” or live wires electrically shielded, like electrical receptacles. Pins, or male connections are power consumers, which are electrically safe when no power is attached.

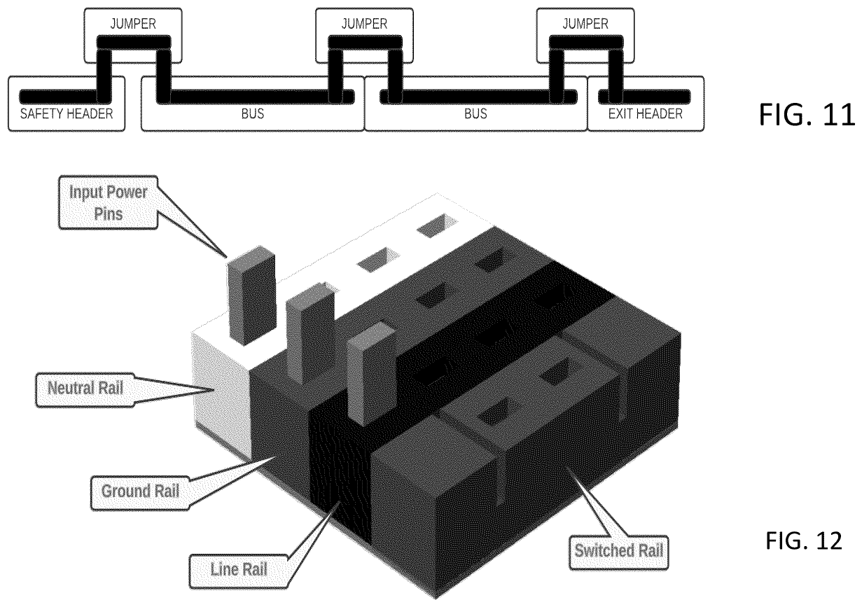

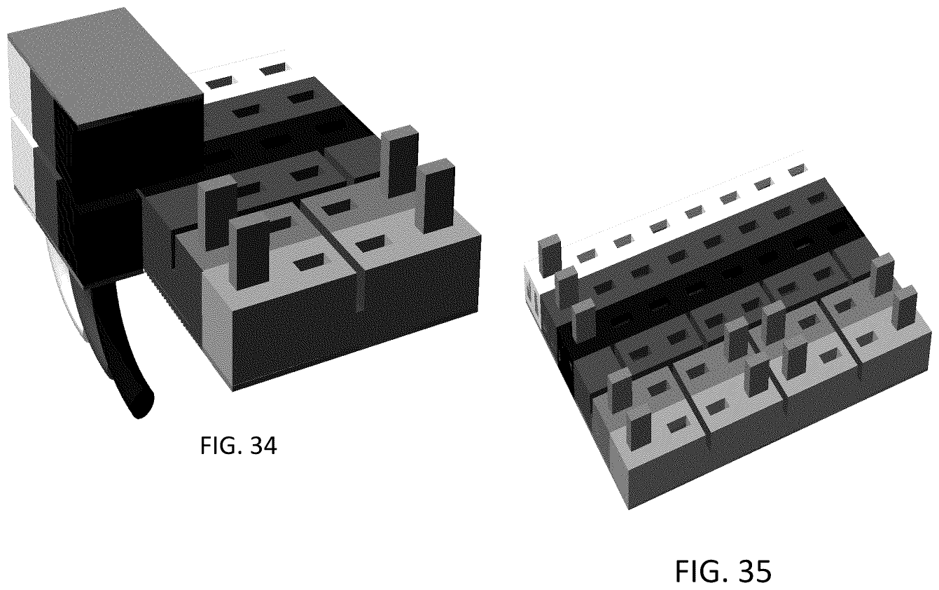

For embodiments desiring a wired power source, such as an integrated switch box, rather than one suitable for disconnect, safety headers can be employed. FIG. 33 and FIG. 34 show the configuration of certain preferred embodiments utilizing a safety header and jumper. See also FIGS. 11 and 14. For these embodiments, the use of a safety jumper can be employed. The safety jumper has connections to both the power header, which is wired, and the bus panel power input pins. The insertion or removal safely governs the power flow allowing the user to be assured power is disconnected during maintenance or similar needs. The wired connector would have wires attached in any convenient way, with the socketed, electrically isolated connector.

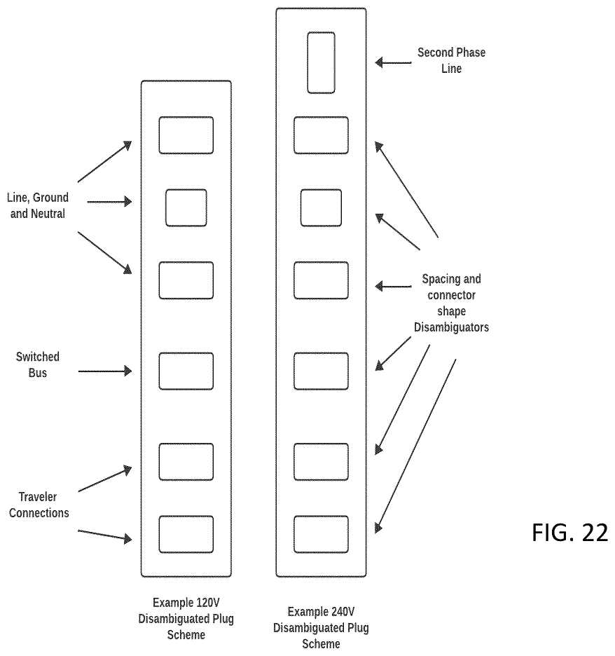

A significant advantage for this invention is the use of a universal connector pattern for the bus. This allows for the plug and play feature and electrically connects a device to all the wired sources it may need. Since these uses can and do differ, the bus panel employs a disambiguation strategy, as shown in FIG. 22 (see also FIG. 29).

### Additional Preferred Embodiments

The use of the bus panel matrix facilitates the use of keyed, failsafe, and securable connectors so they will not be accidentally connected to the wrong wire or bus rail. With composite connectors, where the correct arrangement of pins to sockets, the alignment concern is reduced if not all but eliminated. Composite connectors allow a switch, load/appliance, traveler, power source or extension to be differentiable and provide intended electrical connectivity in a natural way. Each type of connector, though somewhat specialized, can take part in the same ecosystem of bus arrangement.

With composite connectors, it would be just as electrically safe to plug and unplug on a powered bus as it is to use wall receptacles and AC cords.

Composite connectors can also be created that have an indicator of the current power state on the bus or device. The indicator could be a low power led or buzzer that is visible upon inspection, either permanently installed, or used when the junction box is under repair, rework or maintenance. This provides visual or audible feedback to the technician on the power state of the line at the junction box location.

Another use for composite connectors includes a switchable connector for LINE connection and LOAD connection for 3-way switches. Although these switches are electrically identical, their implementation requires either switching from the hot side or switching power to the load side. Using a single composite connector, the user can select the applicable and desired configuration directly on the connector. Alternatively, the connectors can be distinct and selectable by the user and connected to the applicable 3-way switch unit.

Although traditional switches are mechanical, there is growing use of powered switches for use with network or remote control of the switch position. Such switches require use of the neutral line, and the bus panel natively supports this configuration as well.

Other embodiments include differentially shaped port openings on the bus panel for wire connected conditions. For this case, small attachments on the wire ends in these different shapes assist the user in ensuring that the wire they are inserting is intended for that rail.

Using the bus panel for wiring should also be easier for new construction electrical components. Rather than sorting like wires together, wrapping them with wire nut, the electrical connections are simply pushed into place, making the electrician's installation effort faster, more productive, and less rework through the more intuitive assembly process.

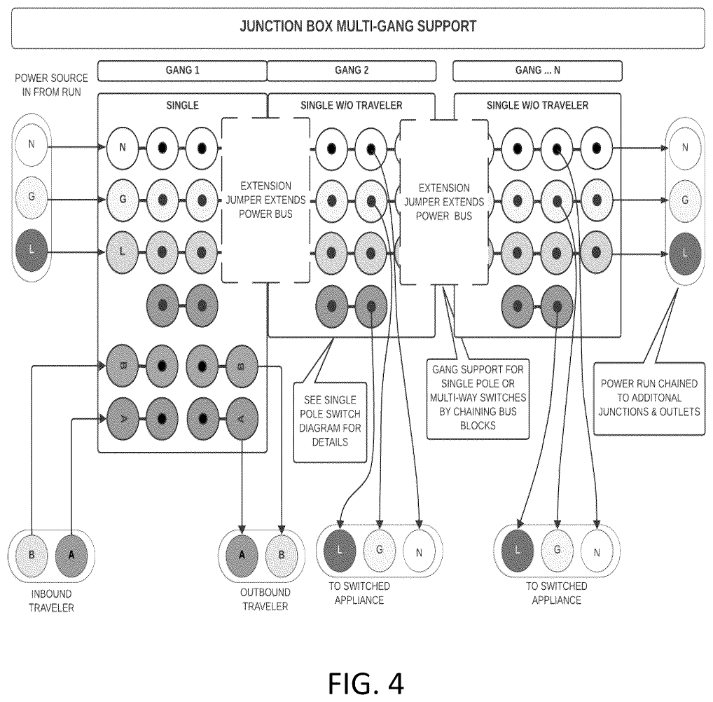

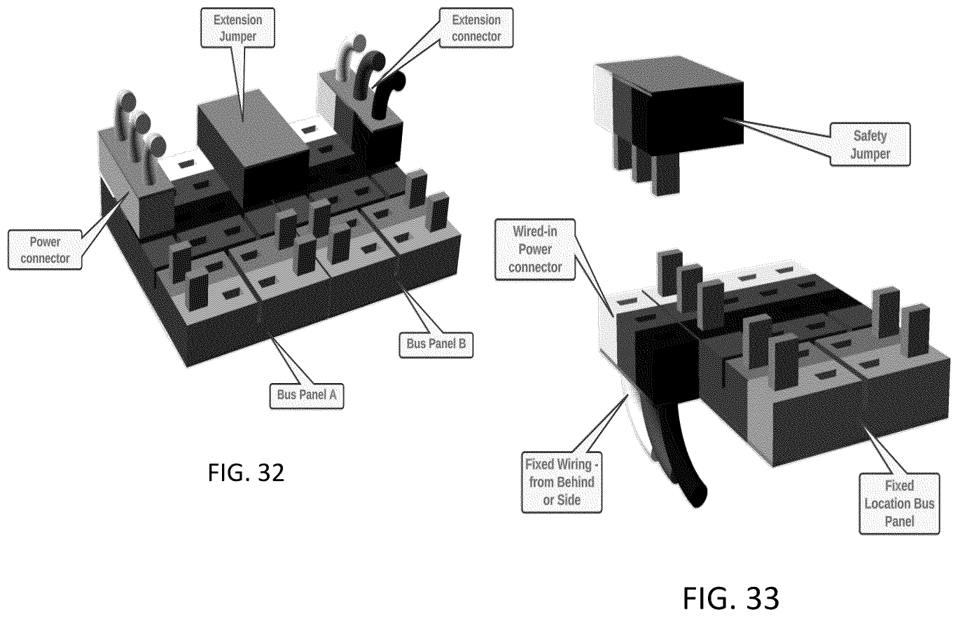

The bus panel embodiments are suitable for daisy chaining, multi-gang, or multi-device, and non-traveler use cases, each with modularized and interchangeable bus panel components. Each embodiment, sharing the same form factor can acts as an extension of other bus panels. FIGS. 4, 10, 32, and 35 illustrate the daisy chaining or connecting of bus panels in certain embodiments. Bus panels also support 240V by placing an additional bus rail for the second LINE wire. 240V appliances would also have distinctive composite connectors to prevent accidental connections.

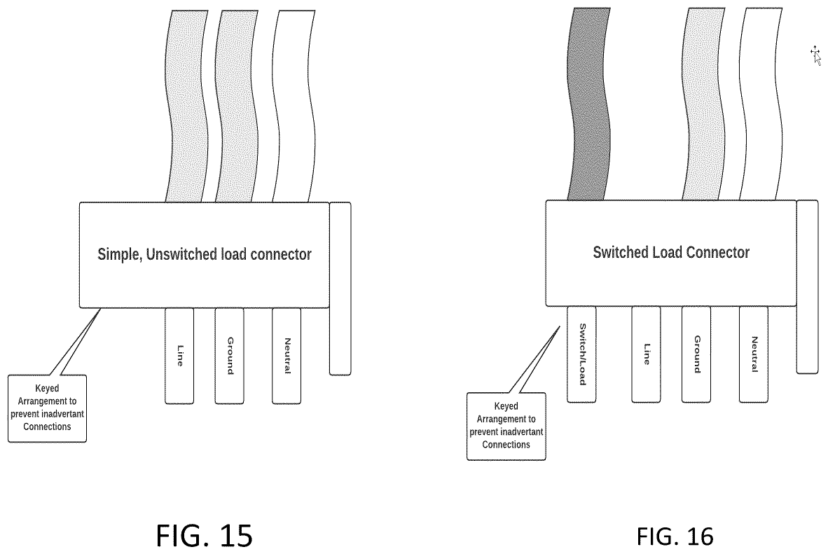

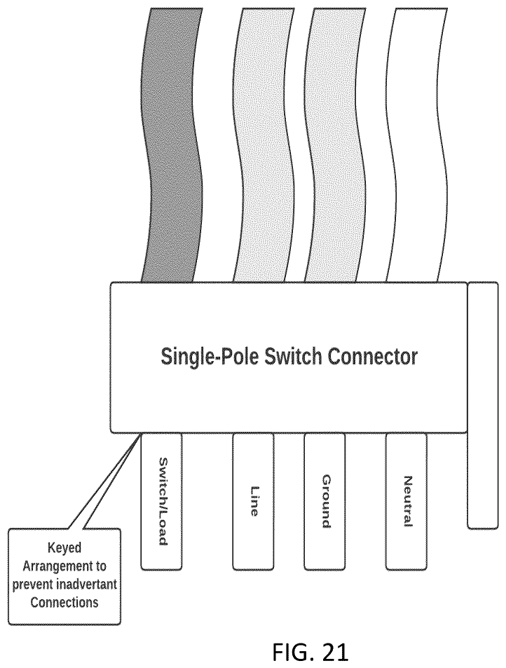

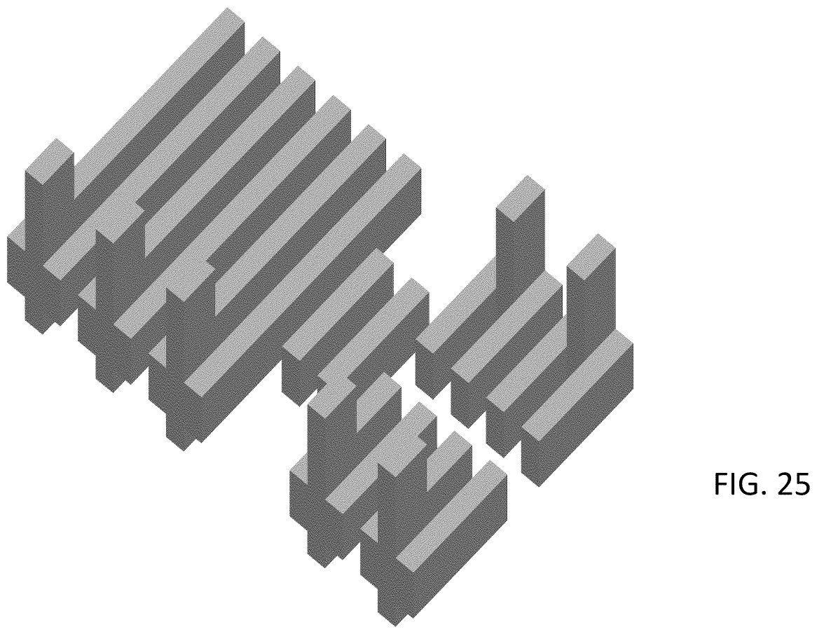

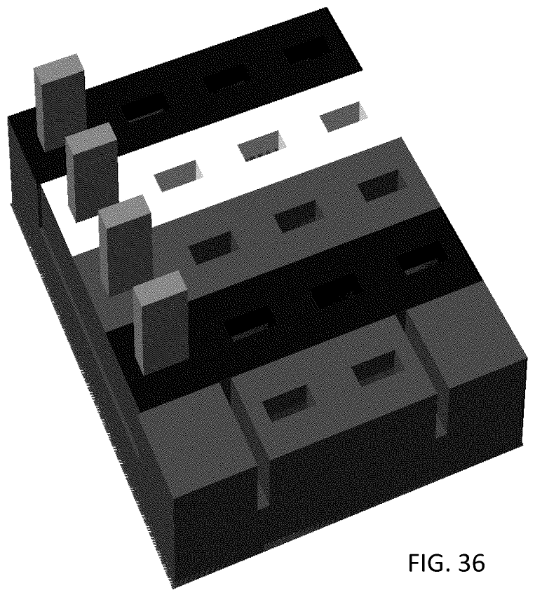

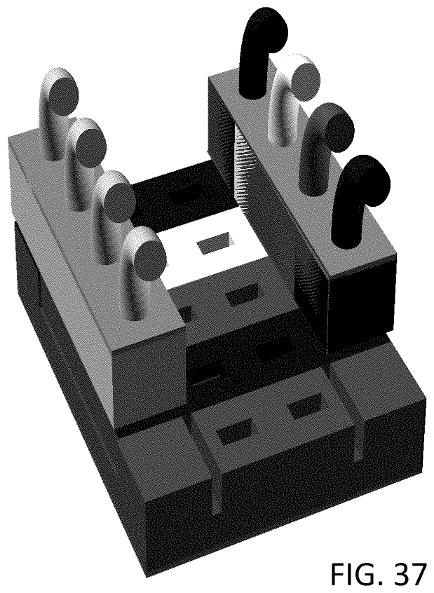

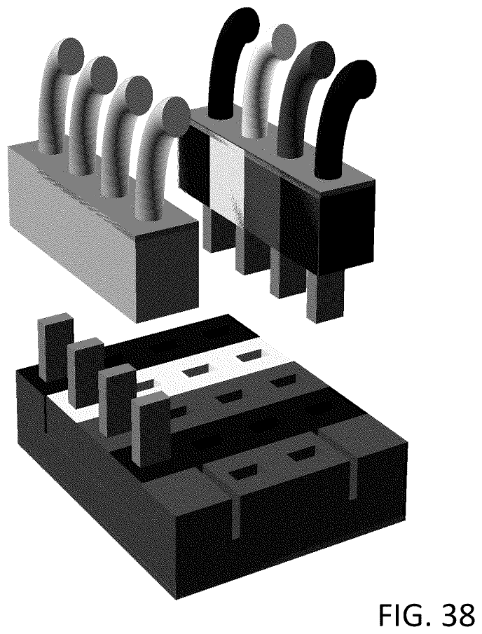

FIGS. 5, 15-16, 21, 25 and 35-38 are examples that show logical configurations for 120V and 240V embodiments.

The bus panel does not always have every port occupied, and in many cases some will always be open. An example of this is the typical 4-way switch that has no need for power access, just the double-throw, double pole switch between traveler wires. For reasons such as this, “blanks” can be used to ensure that the holes are plugged, although it is naturally safe. Spacers, bridges, jumpers can also be daisy chained in for many needs. One use for open ports includes diagnostic equipment. This allows simple, ready access to the electrical behavior on any single run from the breaker box simplifying troubleshooting efforts or monitoring electrical current or wattage to trend usage, power failures, or other events. The bus panel has sockets and pins that easily address and confirm to the requirements defined by the American Wiring Gauge specifications. The preferred embodiments illustrated have sockets where electricity could be live, and pins or spades where, when disconnected, no power can be sourced.

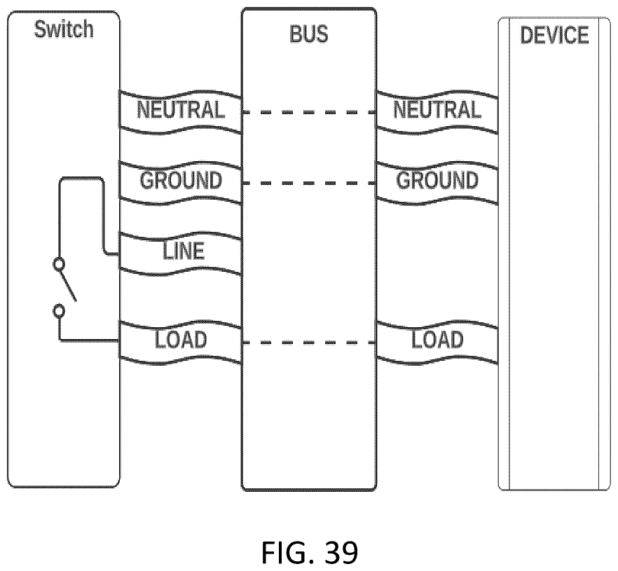

FIG. 39 is a schematic of additional bus matrix embodiments of this invention. These embodiments provide for non-exposed items such as switches and controllers to be on one side of the bus, and the “installed” items such as the source power and wires and harnesses behind the wall are on the back side of the bus for additional safety. Such an arrangement can provide shielding and an interface to and from power and devices to controllers and switches. It may also be mounted or integrated with the junction box so that the work of builders and installers can be sealed, or separated from that of consumers. An example of these embodiments would include a bus panel further comprising connections for source power to be on the back side of the bus when the bus is installed against a wall, and connections for switches and controllers are on the front side of the bus.

These embodiments of FIG. 39 also disambiguate wiring associated with the building with wiring associated with switching, controls and other non-building related connections. Additionally, there is no raw exposure to the line wires for the consumer as the line wires can enter from the rear as well.

Wireless Monitoring and Control: Wireless monitoring and control capabilities are integrated into the bus panel system in certain embodiments. This allows for real-time tracking of energy usage and system performance, and the ability to remotely control various elements of the electrical system, enhancing convenience and energy efficiency.

Automated Diagnostic Features: Certain embodiments incorporate self-diagnostic features that automatically detect, report, and sometimes resolve electrical faults. This enhances safety and reduces the time required for troubleshooting and maintenance.

Scalability and Customization: With the system of this invention being modular, scalable solutions are included with certain embodiments that are tailored to different building sizes and complexities. This allows the offering of customization options for specific applications, including integrating renewable energy or providing smart home compatibility

Enhanced Safety Features: Certain embodiments can provide additional safety features including automatic circuit isolation in case of overloads or faults, improved fire resistance materials, and/or enhanced protection against electrical shocks, especially in environments with higher safety requirements.

Sustainability and Energy Efficiency: Certain embodiments integrate features that promote energy efficiency and sustainability, including providing compatibility with low-power devices or integration with renewable energy sources, that makes the system especially useful for environmentally conscious users.

User Interface and Accessibility: Certain embodiments also include an intuitive user interface, possibly with visual aids or smart assistance, could make the system more accessible to individuals with different levels of expertise and physical abilities.

In particular, certain of these embodiments include: (1) a bus panel system of this invention with integrated wireless communication capabilities for monitoring and controlling electrical installations remotely; (2) an electrical bus panel system of this invention with automated diagnostic and fault resolution features; (3) a scalable and customizable bus panel system of this invention designed to accommodate different building sizes and requirements, including integration with renewable energy sources; (4) an electrical bus panel system of this invention with enhanced safety features, including automatic circuit isolation and improved material resistance to environmental hazards; (5) a bus panel system of this invention optimized for energy efficiency and sustainability, supporting low-power devices and renewable energy integration; and (6) an electrical bus panel system of this invention with an enhanced user interface and accessibility features to accommodate a broader range of users.

### Backwards Compatibility

Contemporary devices that are otherwise joined into wire nuts can utilize the bus panel in several ways. First, the bus panel embodiment can accept simple push-connect connections to the bus. However, an alternative embodiment would have the push-connect to a composite plug. A composite plug would be able to provide the logical grouping of the device and then take advantage of the single column pluggable experience.

Another alternative, but still intermediate embodiment, has the push connections on a connector designed for the bus panel. This allows any device to be converted to the disambiguated panel and take advantage of more of the provided safety features.

The fully realized embodiment has native connectors already attached to the switches ready-made for a bus panel. This takes full advantage of the plug and play experience provided by the invention, including safety and convenience advantages.

### Example Of An Integrated Plug-and-Play Device-Compatible Bus Panel

In certain preferred embodiments of the invention, the electrical bus panel system is designed to support devices and switches manufactured with integrated connectors that eliminate the need for additional wiring during installation. These connectors interface directly with the bus panel ports, streamlining the installation process and ensuring a robust, safe, and error-resistant connection.

### Features Of This Integrated Example

Native Device Integration: Devices (e.g., switches, outlets, appliances) are manufactured with pre-attached connectors specifically designed to match the bus panel's standardized port system. These connectors ensure that the device aligns with the correct power rails (e.g., line, neutral, ground, or traveler).

Plug-and-Play Functionality: The connectors are keyed and coded (e.g., by color, shape, or size) to guarantee proper alignment and to prevent incorrect connections. Installation involves simply plugging the device into the designated port, eliminating the need for tools, wire stripping, or intermediary connectors.

Direct Compatibility: The bus panel ports are configured to accept these native device connectors without requiring any adapters or additional components. This reduces installation time, complexity, and potential points of failure.

Enhanced Safety: The connectors and ports include features such as electrical isolation, shielding, and failsafe mechanisms to ensure safe handling even when the bus panel is powered. For instance, live pins are recessed, and only shielded connectors can engage with the panel.

Support for Multi-Function Devices: Devices with multiple electrical functions (e.g., a switch with integrated diagnostics or a smart controller) can include composite connectors that interface with multiple bus rails simultaneously, providing power, data, and ground connections through a single interface.

Example Use Case: Consider a smart light switch designed for this bus panel system:

The switch comes pre-equipped with a composite connector aligned for direct insertion into the bus panel ports.

Upon installation, the switch is plugged into the junction box, automatically connecting its neutral, line, ground, and traveler wires to the corresponding bus rails.

The plug-and-play nature of the system eliminates the need for traditional wiring, wire nuts, or push connectors, significantly reducing installation time and error risk.

### Advantages

1. Ease of Use: No manual wiring is needed, making installation simple and accessible for non-professionals.
2. Speed: Pre-configured devices are faster to install than traditional systems, saving time for electricians and reducing labor costs.
3. Reliability: Factory-manufactured connectors ensure consistent quality, reducing the likelihood of connection errors or faults.
4. Safety: Integrated safety features protect users during installation and maintenance, even when the system is live.

This Example enhances the modular, scalable nature of the bus panel system by enabling seamless integration of advanced, preconfigured electrical devices. It supports forward compatibility with evolving device standards while maintaining backward compatibility with traditional wiring systems.

### Additional Embodiments

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. An electrical wiring bus panel for providing electricity to at least one component of an electrical system, the bus panel comprising:
(a) a bus comprising a plurality of rails, each rail comprising at least one port through which electrical connections to the rail can be made, the rails organized in horizontal and vertical columns in the bus, and at least one of the rails are capable of being attached to an electrical power source;
(b) wherein the plurality of rails further comprise at least three types of rails, the three types of rails comprising a ground line rail, a neutral line rail, and a power line rail;
(c) wherein the ports for each rail are of a unique and uniform shape and size for each rail and can be used to differentiate the rails from one another, and which ports accept connectors of unique and uniform shape and size for each port; and wherein the ports can be connected to the component of the electrical system without tools by pushing the connectors into place;
(d) a panel that contains the bus, the panel being coded to indicate the types of rails in the bus; and
(e) wherein the at least one component of the electrical system can be connected to at least one of the rails of the bus through at least one port of that rail.

2. The bus panel of claim 1, wherein the bus panel is connected to another bus panel to form a multiple bus panel gang configuration.

3. The bus panel of claim 1, wherein the plurality of rails further comprise a switched line rail for providing a single-pole connection, one or more additional power line rails, a switched line rail for a 3-way switch, a traveler line for a 3-way switch, and/or a traveler line for a 4-way switch.

4. The bus panel of claim 1, further comprising a safety header that connects to ports of at least one of the rails to electrically isolate one of the components of the electrical system.

5. The bus panel of claim 1 for 120V components of the electrical system.

6. The bus panel of claim 1 for 240V components of the electrical system and wherein there is an additional power line rail.

7. The bus panel of claim 1 further comprising integrated wireless communication for monitoring and controlling electrical installations remotely.

8. The bus panel of claim 1 further comprising automated diagnostics and fault resolution.

9. The bus panel of claim 1 that is in a modular conformation to accommodate a particular building size and its requirements, such requirements comprising integration with renewable energy sources and/or smart home compatibility.

10. The bus panel of claim 1 further comprising enhanced safety features, such features comprising automatic circuit isolation and material resistance to environmental hazards.

11. The bus panel of claim 1 that is optimized for energy efficiency and sustainability, supporting low-power devices and renewable energy integration.

12. The bus panel of claim 1 further comprising a user interface and accessibility to accommodate multiple users, each with different levels of expertise and physical ability.

13. The bus panel of claim 1 further comprising connections for source power to be on the back side of the bus panel when the bus panel is installed against a wall, and connections for switches and controllers are on the front side of the bus panel.

14. An electrical wiring bus panel for providing electricity to at least one component of an electrical system, the bus panel comprising:
(a) a bus comprising a plurality of rails, each rail comprising at least one port through which electrical connections to the rail can be made, the rails organized in horizontal and vertical columns, and at least one of the rails is capable of being attached to an electrical power source;
(b) wherein the plurality of rails further comprise at least a ground line rail, a neutral line rail, a power line rail, a switched line rail for providing a single-pole connection, a switched line rail for a 3-way switch, a traveler line for a 3-way switch and/or a traveler line for a 4-way switch;
(c) wherein the ports for each rail are of a unique and uniform shape and size for each rail and can be used to differentiate the rails from one another, and which ports accept connectors of unique and uniform shape and size for each port; and wherein the ports can be connected to the components of the electrical system without tools by pushing the connectors into place;
(d) a panel that contains the bus, the panel being coded to indicate the types of rails in the bus, and wherein the panel is capable of being connected to another bus panel to form a multiple bus panel gang configuration; and
(e) wherein the component of the electrical system can be connected to at least one of the rails of the bus through at least one port of that rail.

15. The bus panel of claim 14 further comprising integrated wireless communication for monitoring and controlling electrical installations remotely.

16. The bus panel of claim 14 further comprising automated diagnostics and fault resolution.

17. The bus panel of claim 14 that is in a modular conformation to accommodate a particular building size and its requirements, such requirements comprising integration with renewable energy sources and/or smart home compatibility.

18. The bus panel of claim 14 further comprising enhanced safety features, such features comprising automatic circuit isolation and material resistance to environmental hazards.

19. The bus panel of claim 14 that is optimized for energy efficiency and sustainability, supporting low-power devices and renewable energy integration.

20. The bus panel of claim 14 further comprising a user interface and accessibility to accommodate multiple users, each with different levels of expertise and physical ability.

21. The bus panel of claim 14 further comprising connections for source power to be on the back side of the bus when the bus is installed against a wall, and connections for switches and controllers are on the front side of the bus.

22. A module system for forming an electrical wiring bus panel for providing electricity to at least one component of an electrical system, the modular system comprising:
(a) at least one bus module capable of comprising a plurality of rails, each rail comprising at least one port through which electrical connections to the rail can be made, the rails organized in horizontal and vertical columns, and at least one of the rails is capable of being attached to an electrical power source;
(b) wherein the plurality of rails further comprise a ground line rail, a neutral line rail, a power line rail, a switched line rail for providing a single-pole connection, a switched line rail for a 3-way switch, a traveler line for a 3-way switch and/or a traveler line for a 4-way switch;
(c) wherein the ports for each rail are of a unique and uniform shape and size for each rail and can be used to differentiate the rails from one another, and which ports accept connectors of unique and uniform shape and size for each port; and wherein the ports can be connected to the component of the electrical system without tools by pushing the connectors into place;
(d) at least one panel module that is capable of containing the bus module, the panel module being coded to indicate the types of rails in the bus, and wherein the panel module is capable of being connected to another bus panel to form a multiple bus panel gang configuration;
(e) wherein the component of the electrical system can be connected to at least one of the rails of the bus through at least one port of that rail; and
(f) wherein the bus module, rails, and panel module are selected based upon the electrical requirements of the component.

23. The modular system of claim 22 further comprising integrated wireless communication for monitoring and controlling electrical installations remotely.

24. The modular system of claim 22 further comprising automated diagnostics and fault resolution.

25. The modular system of claim 22 that is in a conformation to accommodate a particular building size and its requirements, such requirements comprising integration with renewable energy sources and/or smart home compatibility.

26. The modular system of claim 22 further comprising enhanced safety features, such features comprising automatic circuit isolation and material resistance to environmental hazards.

27. The modular system of claim 22 that is optimized for energy efficiency and sustainability, supporting low-power devices and renewable energy integration.

28. The modular system of claim 22 further comprising a user interface and accessibility features to accommodate multiple users, each with different levels of expertise and physical ability.

29. The modular system of claim 22 further comprising connections for source power to be on the back side of the bus when the bus is installed against a wall, and connections for switches and controllers are on the front side of the bus.

30. An electrical wiring bus panel for providing electricity to at least one component of an electrical system, the bus panel comprising:
(a) a bus comprising a plurality of rails, each rail comprising at least one port through which electrical connections to the rail can be made, the rails organized in horizontal and vertical columns, and at least one of the rails is capable of being attached to an electrical power source;
(b) wherein the plurality of rails further comprise at least a ground line rail, a neutral line rail, a power line rail, a switched line rail for providing a single-pole connection, a switched line rail for a 3-way switch, a traveler line for a 3-way switch and/or a traveler line for a 4-way switch;
(c) wherein the ports for each rail are of a unique and uniform shape and size for each rail and can be used to differentiate the rails from one another, and which ports accept connectors of unique and uniform shape and size for each port; and wherein the ports can be connected to the components of the electrical system without tools by pushing the connectors into place;
(d) a panel that contains the bus, the panel being coded to indicate the types of rails in the bus, and wherein the panel is capable of being connected to another bus panel to form a multiple bus panel gang configuration;
(e) wherein the component of the electrical system can be connected to at least one of the rails of the bus through at least one port of that rail;
(f) integrated wireless communication for monitoring and controlling electrical installations remotely;
(g) integrated and automated diagnostics and fault resolution;
(h) wherein the bus panel is in a modular conformation to accommodate a particular building size and its requirements, such requirements comprising integration with renewable energy sources and/or smart home compatibility;
(i) enhanced safety features, such features comprising automatic circuit isolation and material resistance to environmental hazards;
(j) wherein the bus panel is optimized for energy efficiency and sustainability, supporting low-power devices and renewable energy integration;
(k) a user interface and accessibility to accommodate multiple users, each with different levels of expertise and physical ability; and
(l) connections for source power is on the back side of the bus panel when the bus panel is installed against a wall, and connections for switches and controllers are on the front side of the bus panel.

31. An electrical bus panel for installation of at least one of multiple types of devices, the types of devices comprising switches, outlets and appliances, the bus panel comprising
(a) multiple bus panel rails, the bus panel rails comprising a line rail, a neutral rail, a ground rail, and/or a traveler rail;
(b) multiple bus panel ports, each bus panel port configured to accept the installation of at least one of multiple plug-and-play connectors;
(c) each plug-and-play connector configured, keyed and coded for, and attached to, one type of device;
(d) the installation of the plug-and-play connector on the bus panel port does not require any adapters, additional components, additional wiring, tools, wire stripping, or intermediary connectors; and
(e) the installation of the plug-and-play connector aligns each type of device with particular bus panel rails.

32. The bus panel of claim 31, wherein the plug-and-play connectors connect with multiple bus panel rails.

33. The bus panel of claim 31, wherein the use of plug-and-play connectors reduces installation time, complexity, potential points of failure, and errors in installation.
